(19) United States
(12) Patent Application Publication
(10) Pub. No.: US 2017/0211764 A1
(43) Pub. Date: Jul. 27, 2017

(54) Indoor Sunshine Simulation Apparatus and Methods

(71) Applicants: Walter Price, Castleton, VA (US); Marilyn Price, Castleton, VA (US)

(72) Inventors: Walter Price, Castleton, VA (US); Marilyn Price, Castleton, VA (US)

(21) Appl. No.: 15/515,143

(22) PCT Filed: Sep. 28, 2015
(86) PCT No.: PCT/US15/52662

§ 371 Date: Mar. 28, 2017

Related U.S. Application Data
(60) Provisional application No. 62/056,601, filed on Sep. 28, 2014.

(51) Int. Cl. F21S 8/00; F21V 3/00; F21V 11/06; F21V 21/15

(52) U.S. Cl. CPC F21S 8/006; F21V 21/15; F21V 3/00; F21V 11/065; F21Y 2115/10

(57) ABSTRACT

Apparatus and methods to simulate current local outdoor lighting conditions, current lighting conditions of another location, or programmed outdoor lighting conditions are provided. The apparatus comprises at least one lighting device and one or more computers for controlling the lighting device, and may include one or more photosensors. The apparatus may resemble a window and may be installed on or in a building surface. The lighting device comprises one or multiple lighting elements to emit a spectrum of light, at variable brightness levels, to reproduce a range of outdoor light conditions. The apparatus may comprise elements to produce a directionality or diffuseness to the emitted light. One or more photosensors may sense outdoor lighting conditions, and transmit that information to the computer controlling the apparatus. The apparatus may be programmed without the photosensor, or be internet-connected to access programming or current lighting conditions of another location and/or time.

### FIELD OF THE INVENTION

The present invention relates to indoor simulation of outdoor light using a disguised lighting device, that is, a lighting device made to resemble a window or other item that is not typically a source of artificial light. In particular, the present invention relates to a lighting device comprising a housing, a light source, means of directing or diffusing the emitted light, a connection to one or more photosensors, and at least one computer to control or program the lighting device.

### BACKGROUND OF THE INVENTION

Natural light is important to human health in several ways. Exposure to natural light can contribute to production and regulation of hormones, such as cortisol, and vitamin D; can regulate circadian rhythms; can help to counter symptoms of seasonal affective disorder and make other mood improvements in people, including countering depressing; and can help to counter memory loss. Natural light has been shown to boost alertness and productivity, and make people feel less stressed. Exposure to adequate levels of natural light at appropriate times of day has been shown to improve sleep patterns, alertness, productivity, general mood, and physiology.

Living and working indoors reduces exposure to natural light. Windows provide natural light and give occupants a sense of being in touch with the outside world. But, it is not always feasible to install a window in a space, such as an interior room or a room below grade, and some windows, such as those looking onto narrow alleys or courtyards, or shaded by other structures, may not admit significant amounts of natural light. When windows are absent or inadequate, a living or working space is less valued and more likely to negatively impact the health, mood, and productivity of occupants.

To replace the reduced exposure to natural light that can result from many such situations, many attempts have been made to simulate natural outdoor light for the indoor environment, both for homes and workplaces. But, simulating natural light accurately requires the ability to control and alter the color spectrum (the range wavelengths of light, and their relative intensities) of the emitted light, and the overall brightness of the light. To more fully simulate the effect of a window requires the ability to control the directionality of the light emitted from the light source—that is, to imitate sunlight coming in a window requires the ability to direct the light emitted from the light source side-to-side and up-and-down. By way of example, such a simulator of outdoor light could emit light and track across a room over the course of a day, imitating the sun's apparent arc across the sky. To fully simulate a window on the outdoors, a natural light simulator must also be able to sense outdoor conditions in real time, and replicate them in real time for color spectrum, brightness, and directionality by altering the overall and relative amounts of light emitted from one or more light sources, and directing the light emitted from the natural light simulator.

In addition, while lighting devices are omnipresent and vital in people's homes and workplaces, hiding their function and minimizing their intrusion into the interior space, while retaining their effectiveness and efficiency, are often desirable.

Among other examples of the prior art of natural-light-imitating products and methods, U.S. Pat. Nos. 5,251,392, 5,426,879, and 7,784,204, and U.S. Publication Nos. 2013/0165741 and 2010/0079992, variously disclose lighting devices constructed to resemble artificial or wall-hangable windows, or pictures simulating outdoor scenes or other images. U.S. Pat. No. 5,589,741 discloses a light source and a computer to control it, capable of programming simulation of the photoperiod of a place and time. But, all of the prior art falls short of realistic simulation of natural light indoors, and none disclose implementing means of real-time simulation of local or distant outdoor conditions. The products and methods disclosed in U.S. Pat. Nos. 5,251,392, 5,426,879, and 5,589,741 do not disclose means or methods to control the color spectrum or directionality of the light they emit, or to simulate real-time conditions. U.S. Publication Nos. 2013/0165741 and 2010/0079992 disclose not artificial windows, but lighting devices disguised with frames and covers or image displays, and they do not simulate a natural daylight spectrum or have the ability to control the light spectrum they emit, or to control the directionality of light emitted, or to simulate real-time conditions. U.S. Pat. No. 7,784,204 discloses controlling the color spectrum of the light emitted, and programming or user input for control of the light emitted, but does not disclose control over the directionality of the light emitted. Additionally, U.S. Pat. No. 7,784,204 briefly mentions the possibility of inputting signals to control the light source using a sensor, but does not disclose a system or method for doing so, and U.S. Pat. No. 5,251,392 mentions contemplation of control of the directionality of light emitted, but does not describe or disclose how that might be done.

Collectively, the disadvantages of existing products, such as those disclosed in the prior art, include incomplete or inadequate control over the color spectrum of emitted light, limited programmatic control over the brightness and color spectrum of the light, no control over the directionality of the light emitted, and no disclosed means to control the light characteristics from an outdoors sensor or sensors, whether local or remote. Accordingly, the existing products cannot provide lighting that accurately mimics with emitted light the light transmitted by a window in a wall.

Additionally, while using such non-realistic simulators of natural light may provide some benefits to human health or well-being, but without full control over brightness, color spectrum, and directionality, and without real-time input of current outdoor conditions, such simulators will always fall short of accurate simulation of the then-current outdoor light. Accordingly, they are likely to cause cognitive dissonance in users who can see actual windows while viewing existing products (or soon after viewing them, for instance by going outdoors). It seems possible then that the current art may fall short of providing the full range of benefits to human physical and mental health, and alertness and productivity, that could be achieved by an accurate simulator of natural light—one that is capable of synchronizing its light output with current conditions.

In addition, while some existing products imitate windows, there exists a need for a lighting product that can be seamlessly installed in a wall without protruding farther into a room than a conventional window's sill and casing would, so as to maximize the imitation of a natural window, and minimize the use of interior space.

Thus, there exists a consumer need for a lighting device capable of accurately reproducing natural outdoor light. Additionally, there is a need for a lighting device that is capable of synchronizing its light output with current conditions, both local current conditions, or the actual current conditions of another location. Further, there is a need for a lighting device that can be programmed locally, or remotely, to accurately simulate the light transmission of a window at another location or time of day or year. Finally, there is a need for a lighting device that appears to be a window mounted in a wall, with minimal protrusion into the interior space.

### SUMMARY OF THE INVENTION

The present invention meets all these needs, generating a realistic imitation of natural lighting conditions inside an interior living or working space. The realistic imitation may include reproduction or approximation of one or more outdoor lighting conditions, including but not limited to brightness, color spectrum, and direction or diffuseness of light. The invention disclosed here does this by providing a lighting device with: a housing that may be shaped like a window and installed in a wall; one or more lighting elements; one or more light altering means including but not limited to mirrors, refractive or Fresnel lenses, apertures, louvers, diffusers and/or screens, one or more photosensors which may be configured to sense and transmit lighting conditions to a computer; and a computer with methods to control the lighting elements and the elements that control the positioning of the lighting elements, and the elements that alter the light emitted, to simulate a) current local outdoor lighting conditions according to the data received from the one or more photosensors, or b) current lighting conditions of another location based on data received from a source external to the lighting device, or c) programmed outdoor lighting conditions of any time and location.

To blend into a room, the lighting device, referred to herein as a Natural

Light Simulation Window (“NLSW”), may be built to resemble a window, with a frame comprising a head, jambs, and sill, possibly containing multiple sashes, which may have grilles or muntins. The NLSW may be installed on or in a wall or other building surface, such as in the ceiling to simulate a skylight. The appearance of the NLSW is important because occupants of a living or working space generally expect it to have windows. The NLSW may also be built in any other shape, configuration, or appearance.

To simulate the color spectrum of natural lights, which varies over the course of a day and day-to-day, the NLSW includes one or multiple lighting elements capable of emitting a range of wavelengths of light sufficient to reproduce the range of natural light conditions present outside of a building. To simulate the variable intensity of natural light, the one or more lighting elements may be operated at a range of brightness levels, ranging from off to sufficient to provide light output to mimic the brightness of midday sunlight that would come through a window equivalent in size and placement to a NLSW.

To simulate the apparent motion of the sun across the sky as Earth spins, and to simulate the variable zenith of the sun in the sky over the course of a year, the NLSW may also have computer-controlled light altering means, including but not limited to mirrors, refractive or Fresnel lenses, apertures, louvers, diffusers, screens, or other elements capable of producing both a horizontal directionality and a vertical directionality to the light emitted from the NLSW. The NLSW may also comprise computer-controlled elements to control the orientation of the lighting elements, so as to further allow the NLSW to reproduce the directionality or diffuseness of real-time or other outdoor lighting conditions. These mechanisms guiding and altering the light emitted from the NLSW may be controlled to vary over the course of a day, and over the course of a year, giving the NLSW the ability to simulate with emitted light the track of the sun across the sky. To simulate the directness or diffuseness of natural light conditions, which may vary with atmospheric conditions including clouds, haze, mist, fog, and other factor, the NLSW may have one or more diffusers, screens, or other means to alter or disperse the light emitted from the NLSW.

A computer controls the lighting elements, directing the color spectrum and intensity of light emitted, and controls the light altering means, (i) directing the light at particular angles along both horizontal and vertical planes relative to the axes of the NLSW, or emitting the light broadly into the room without directing it at particular angles, and (ii) diffusing and/or screening the light to simulate various conditions of atmospheric clarity or obscurity. The computer may also be able to simulate transitory lighting effects, such as the effect of clouds casting shadows, dappled shade such as that cast by a tree, or flashes of lightning.

To sense outdoor conditions, one or more photosensors may be placed outdoors in a location and position to sense outdoor lighting conditions that the user desires to simulate indoors with the NLSW. The photosensor or photosensors transmit that information to the computer controlling the lighting elements and the light altering means, and the computer uses that information to control, in real time, the lighting elements and the light altering means. The NLSW may also be programmed directly without use of the photosensor through input means now known or later invented, or the computer may be connected to the internet for the purpose of accessing or receiving programming remotely, or to receive the current lighting conditions of another location.

Accordingly, the NLSW can be used to provide simulated natural light where a window providing actual natural light cannot be installed, or is not practical or desired, or could not provide useful or significant amounts of natural light. By installing one or more NLSWs, indoor spaces such as a below-grade basement, an interior room, or a room with a wall whose exterior faces narrow passages, dark courtyards, or structures that shade the wall may be lit with realistic simulated natural light, providing the occupants the benefits of natural light, improving the satisfaction and quality of life for the occupants, and enhancing the usefulness and value of the property. The NLSW may also be used in a room with some natural light, but where more is desired. The NLSW can be used in such a room without appearing out of place, causing cognitive dissonance, or interfering with circadian rhythms, because it can be operated to emit light that is synchronized, in color spectrum, brightness, diffuseness, and direction, with the light transmitted by the existing windows.

Additionally, consumers wish to have interior spaces decorated in any of several ways, and without lighting devices that interfere or stand out. The NLSW may be constructed in a variety of sizes and shapes, from many materials and with a variety of finishes, to match virtually any decor.

### BRIEF DESCRIPTION OF THE DRAWINGS

In the drawings, like reference characters generally refer to the same components of the device throughout the different figures.

In the following description, various embodiments of the present invention are described with reference to the following drawings, in which:

FIG. 1 is a front perspective view of an embodiment of the present invention.

FIG. 2 is an exploded perspective view of multiple panels of an embodiment of the present invention.

FIG. 3A is an exploded perspective view of an embodiment of the present invention, illustrating an arrangement of panels, lighting elements, connectors, and holes through which the lighting elements emit light.

FIG. 3B is a cross-sectional view of the arrangement of panels, lighting elements, connectors, and holes shown in FIG. 3A, illustrating the range of motion of such connectors and the movement of the lighting elements, in an embodiment of the present invention.

FIG. 4A is a front perspective view of another embodiment of the present invention, illustrating an arrangement of lighting elements on rotatable louvers.

FIG. 4B is a side perspective view of the embodiment of the present invention illustrated in FIG. 4A, illustrating a possible arrangement of such rotatable louvers.

FIG. 5 is a front perspective view of another embodiment of the present invention, illustrating an arrangement by which it might be placed in a structure, and further illustrating with a front elevation a possible arrangement of lighting elements on movable components.

FIG. 6A is a side elevation view of an arrangement of lighting elements and associated components of an embodiment of the present invention.

FIG. 6B is a front elevation view of the arrangement of lighting elements and associated components of an embodiment of the present invention illustrated in FIG. 6A.

FIG. 7 is a side perspective view of the arrangement of lighting elements and associated components of an embodiment of the present invention illustrated in FIG. 6A and FIG. 6B.

FIG. 8 is a front perspective view of selected components related to controlling the motion of the lighting elements and associated components of an embodiment of the present invention, showing a view of the underside of the sill and the top of the ladder elevation means, as well as related components.

FIG. 9 depicts an exemplary method of the present invention to control the elements of an embodiment of the present invention.

### DETAILED DESCRIPTION OF THE DRAWINGS

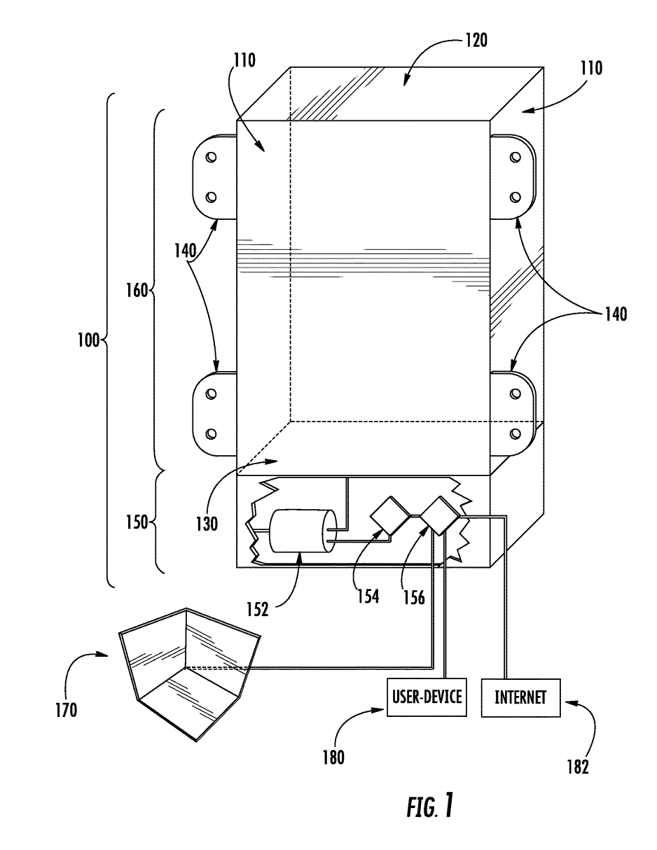

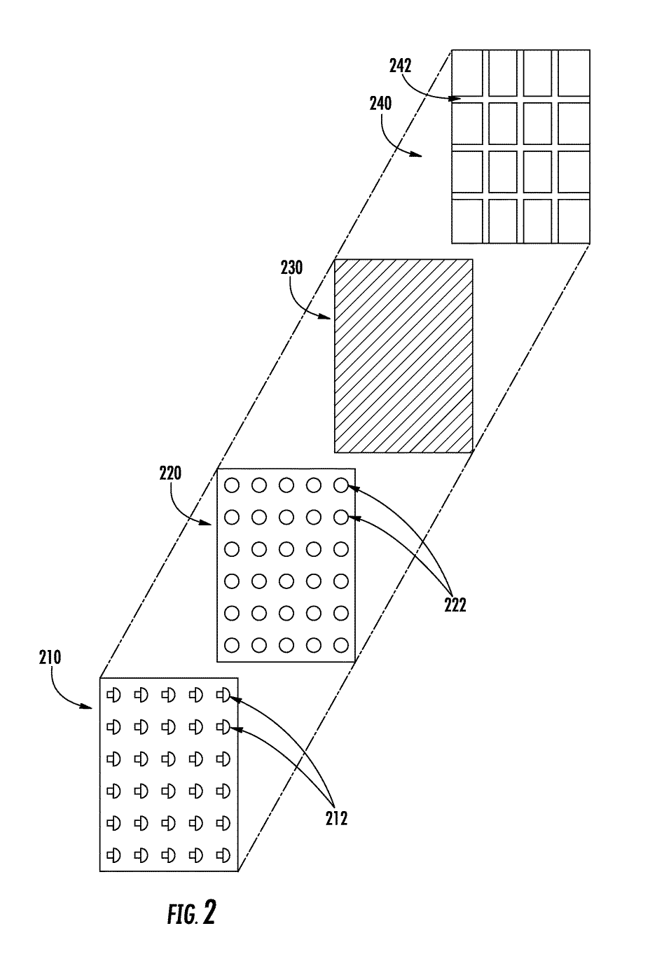

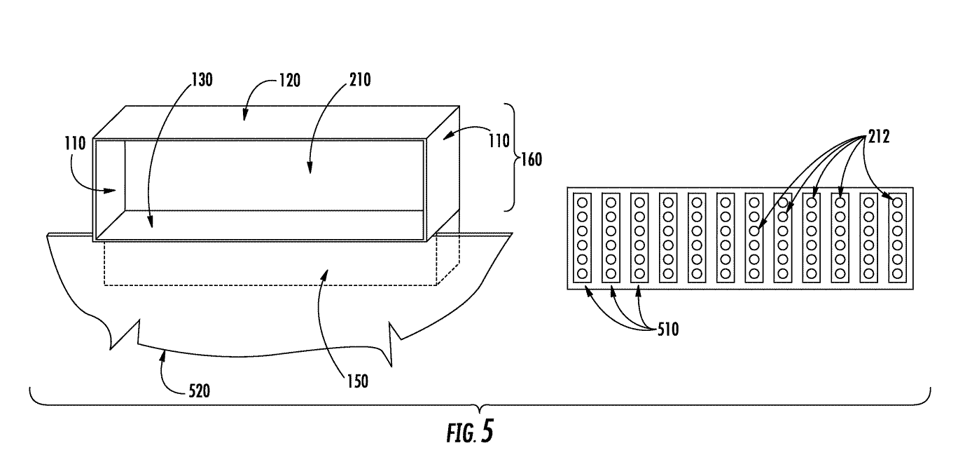

As depicted in FIG. 1 and FIG. 2, it has been found advantageous to have the NLSW 100 described herein comprise a plurality of panels fixedly connected to each other to form an enclosure, including but not limited to a back panel 210, and a front panel 230, as well as a plurality of side panels 110 and a top panel 120 and a bottom panel 130; any of the plurality of panels may have mounting means 140, illustrated in FIG. 1 as attached to the side panels 110 for attachment of the NLSW 100 to the interior structural members or surface of a wall 520, as illustrated in FIG. 5, or ceiling, or other element of the building or object in which the NLSW 100 is to be installed. The NLSW 100 may further, in some embodiments, comprise a middle panel 220, a trim panel 240, and/or an operating tray 150, which may be located below or to the side of the display portion 160 of the NLSW 100, and which operating tray 150 may comprise a location for containing components, including but not limited to mechanical and/or electrical components of the NLSW 100, as set forth in greater detail below. It is to be understood that in other embodiments of the NLSW 100, the overall shape may be round or a shape other than a square or a rectangle, that the above-described panels comprising the NLSW 100 may be of any shapes and may be attached to each other in different ways and in different arrangements, and that the NLSW 100 may be built or oriented as a window with its long axis either horizontal or vertical. The NLSW 100 further comprises a power connection to a power source, and a control means which may comprise a computer 154.

The NLSW 100 further comprises a plurality of lighting elements 212, disposed in the enclosure formed by the plurality of panels, which in some embodiments of the present invention are attached to the back panel 210. It has been found advantageous to have the lighting elements 212 comprise light-emitting diodes (LEDs), but they may be any other type lighting element now known or later invented. The lighting elements 212 may include a plurality of lighting elements that are capable of changing the color of light they emit, or in other embodiments, the lighting elements 212 may include one or more pluralities of lighting elements that emit non-white light, including but not limited to red, green, or blue LEDs.

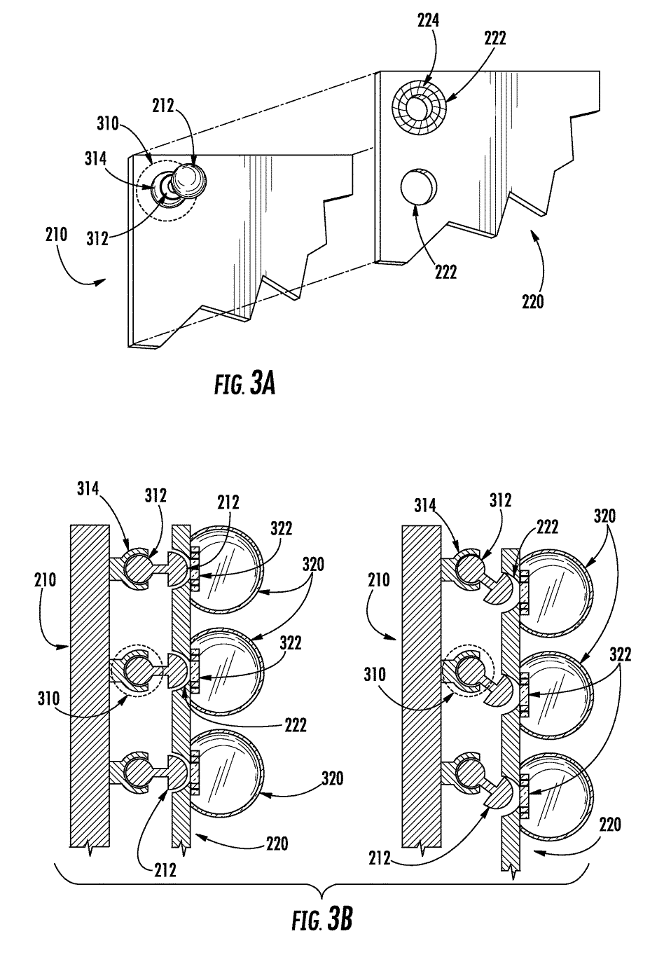

It has been found advantageous to have, with reference to FIG. 3A and FIG. 3B, each of the plurality of lighting elements 212 be attached to the back panel 210 with one or more of a plurality of connectors 310, which are fixedly attached to both the lighting elements 212 and the back panel 210 and are capable of movement internal to the connectors 310. As shown in FIG. 3A and FIG. 3B, each of the plurality of connectors 310 may comprise a ball 312 and a socket 314, or the connectors 310 may be other devices or hinges capable of simultaneous motion in two perpendicular directions, such as up/down and side/side in the reference frame of the NLSW 100. The lighting elements 212 may be, it has been found advantageous, attached to the back panel 210 in such a way that the neutral position of the connectors 310 has the lighting elements 212 oriented perpendicularly to the back panel 210, so that the light they emit would be directed away from the back panel 210 and towards the front panel 230. The lighting elements 212 are connected electrically to the computer 154 for control and to the power connection.

The middle panel 220 may comprise a plurality of holes 222, and may be disposed between the back panel and the front panel. The middle panel 220 may comprise a rigid or semi-rigid material. A plurality of the holes 222 align with the lighting elements 212 when the lighting elements 212 are in their neutral position, perpendicular to the back panel 210. With LED lighting elements 212, it has been found advantageous to have the plurality of holes 222 be circular and aligned concentrically with the long axis of the lighting elements 212, which is perpendicular to the back panel 210, though it will be apparent to one of skill in the art that other shapes of holes 222 and arrangements of holes 222 in relation to lighting elements 212 are possible with other types of lighting elements 212. The plurality of holes 222 may be lined with a plurality of hole liners 224.

It has been found advantageous, in the present invention, that the middle panel 220 may have light redirection means 320 attached to it to redirect the light emitted by the lighting elements 212 through the holes 222. The light redirection means 320 may be placed on, over, or near the holes 222, in whatever arrangement is best suited to redirecting the light from the lighting elements 212, as will be apparent to one of skill in the art. The light redirection means 320 may be Fresnel lenses, mirrors, diffraction gratings, or other means for optimizing the light emitted by the lighting elements 212 for projection out of the NLSW 100. The light redirection means 320 may be placed over or situated near each of the holes 222 individually, as illustrated by exemplary light redirection element 322 in FIG. 3B, or one or more of the light redirection means 320 may be placed or situated so as to redirect the light from a plurality of the holes 222. In other embodiments of the present invention, it has been found advantageous to have the light redirection means 320 attached to the lighting elements 212 directly or to the plurality of hole liners 224, as will be apparent to one skilled in the art, depending in part on which of the middle panel 220, the back panel 210, or the lighting elements 212 are the moveable part or parts.

It has been found advantageous to have an element of the NLSW 100 be moveable. In some embodiments of the present invention, the middle panel 220 may be moveably connected to other elements of the enclosure in order to change the directionality of the light emitted from the NLSW 100. The middle panel 220 may be attached to one or more of the back panel 210, side panels 110, top panel 120, or bottom panel 130 with mounts capable of simultaneous motion in two perpendicular directions, such as up/down and side/side in the reference frame of the NLSW 100. The middle panel 220 may be attached to a plurality of motors 152, which may be configured to push the middle panel 220 in any combination of two perpendicular directions simultaneously, such as up/down and side/side in the reference frame of the NLSW 100. In other embodiments of the present invention, the back panel 210 may be similarly moveably connected to other elements of the enclosure while the middle panel 220 remains stationary. In still other embodiments of the invention, both the middle panel 220 and the back panel 210 may be stationary, and one or more of the lighting elements 212 may be moveably connected to other elements of the enclosure by means of the plurality of motors 152 attached to one or more of the moveable lighting elements 212. The plurality of motors 152 may be located in the operating tray 150, as illustrated in FIG. 1, or mounted to the back panel 210, side panels 110, top panel 120, or other location in the NLSW 100.

It has been found advantageous to have the holes 222 may be lined with hole liners 224 disposed concentrically with the plurality of lighting elements 212 and concentrically inside of the plurality of holes 222, or in other suitable arrangements with other types of lighting elements 212, as will be apparent to one of skill in the art. The hole liners 224 may be composed of a soft or malleable material, including but not limited to a soft rubber, a foam, or a thick-pile synthetic fabric, suitable for being in physical contact with the lighting elements 212 and deforming as necessary to cushion the lighting elements 212 while the middle panel 220 moves. In this way, as the middle panel 220 moves relative to the back panel, it simultaneously pushes each of the lighting elements 212 protruding through the holes 222, and cushioned with the hole liners 224, to all point in the same direction, away from or perpendicular to the back panel 210.

The motion of the moveable element of the NLSW 100, that is of a moveable middle panel 220, or of a moveable back panel 210, or moveable lighting elements 212, may be controlled by the control means, using real-time input or by programmed input. It has been found advantageous to have such motion controlled in such a way that it directs the light from the NLSW 100 into the room to emulate current local outdoor lighting conditions, and also the light projected by the lighting elements 212 emulates current local outdoor lighting conditions. At times, this can mean projecting a bright light at a nearly horizontal angle to mimic direct sunlight at sunrise or sunset. At other times, the NLSW 100 may project light sharply downward, to mimic direct sunlight during the middle of the day. The control means, such as the computer 154, it has been found advantageous, may be connected, by a wire or wirelessly, or other means now known or later invented, to one or more photosensors 170 capable of sensing the direction from which light is striking it. The plurality of photosensors 170 may be a right-angle reflector, that is, three photoreceptors arranged perpendicular to each other, like the sides of a cube forming a corner, as illustrated in FIG. 1, and by the computer 154 processing the information gathered from each face of such a photosensor 170, together capable of sensing the direction of the light striking it. Alternatively, the plurality of photosensors 170 may be one or more devices or arrangements of light-detection sensors capable of the same functions. The plurality of photosensors 170 is also capable of detecting the brightness and color spectrum of light incident upon the plurality of photosensors 170.

The information from the plurality of photosensors 170 may be used by the computer 154 to control the NLSW 100 to emulate lighting conditions, as described here, and below in greater detail in the description of the inventive methods. The computer 154, which may be located in the operating tray 150, does so by controlling, by transmitting motor control signals, the plurality of motors 152 to move the middle panel 220 or other moveable components of the NLSW 100, which directs the light from the NLSW 100. It has been found advantageous to have the computer 154 further simulate lighting conditions by controlling, by transmitting lighting control signals, the intensity of light emitted by the lighting elements 212 and the color spectrum of the light emitted by the lighting elements 212, to further simulate current outdoor lighting conditions. The NLSW 100 may project light of different colors, or different brightness levels, or very bright flashes, to imitate outdoor conditions such as a colorful sky, a cloudy day, alternating sun and shade from clouds, or flashes of lightning. The NLSW 100 may, it has been found advantageous, be capable of controlling individual lighting elements 212 or groups of lighting elements 212 separately from other lighting elements 212, specifically, by the computer transmitting 940 a first set of lighting control signals to a first plurality of lighting elements 212, and the computer transmitting 940 a second set of lighting control signals to a second plurality of lighting elements 212. It will be obvious to one of skill in the art that more than two such sets of lighting control signals to more than two such pluralities of lighting elements 212 may be possible and desirable, in some embodiments of the present invention.

In other embodiments of the invention, a first set of information about lighting conditions to emulate may come from instruments located remotely and transmitting real-time data, and connected to the control means, such as the computer 154, via the input/output means 156 over the internet 182. In still other embodiments, the first set of information about lighting conditions to emulate by the control means may be a programmed simulated day, or other time period, of lighting. Such programming may be done locally, and into the computer 154 from a user device 180, or may be downloaded to the computer 154 over the internet 182, or using other means now known or later invented, as described below in greater detail in the description of the inventive methods. The connection between the computer 154, input/output means 156, and user device 180 or internet 182, may be wired or wireless, and may use any communication protocol now known or later invented.

It has been found advantageous to have the front panel 230 comprise material to diffuse light from the plurality of lighting elements 212. The front panel 230 may be clear, or frosted, or cross-hatched, or use other materials or means to diffuse the light emitted or otherwise alter it.

It has been found advantageous to have the NLSW 100 comprise front louvers which may have the appearance and function of slatted blinds, such as being operable to rotate and direct the light emitted by the lighting elements 212 further downward. Such optional louvers may be situated over the front panel 230. The NLSW 100 may also have window-trim components, which are intended to make the NLSW 100 appear more like a standard window, including but not limited to muntins 242 as depicted in FIG. 2, or mullions, curtains or curtain-rod-attachment sites.

In other embodiments of the present invention, the directionality of the light may be controlled not by changing the orientation of the lighting elements 212 by moving the middle panel 220, the back panel 210, or the lighting elements 212 themselves, but through the use of rotatable louver units 410. In these embodiments, a plurality of panels are fixedly connected to each other to form an enclosure, including but not limited to a back panel 210, and a front panel 230, as well as a plurality of side panels 110 and a top panel 120 and a bottom panel 130; any of the plurality of panels may have mounting means 140.

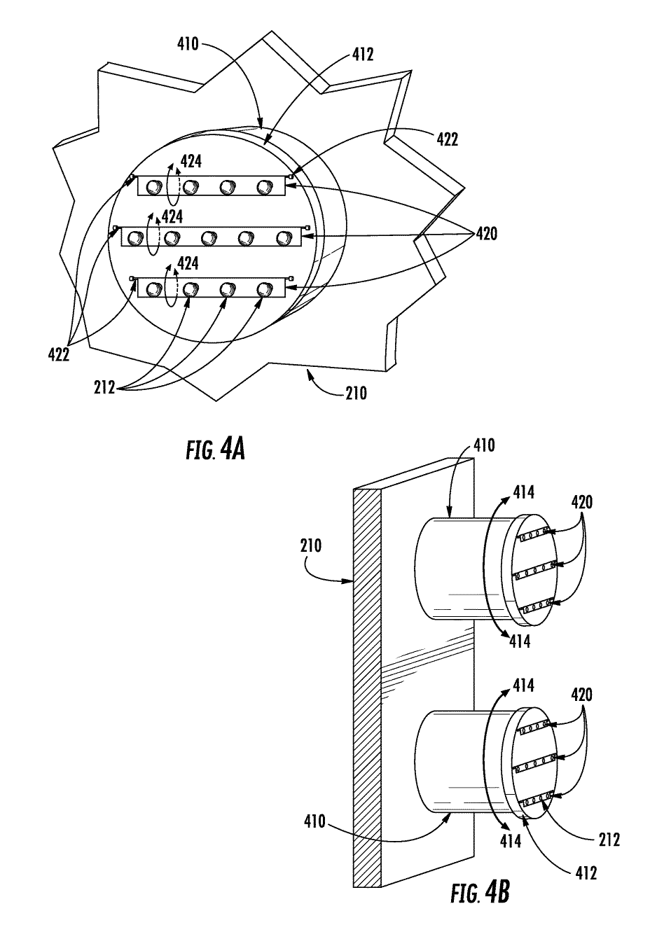

As depicted in FIG. 4A and FIG. 4B, a plurality of rotatable louver units 410 may be cylindrical units, each of the plurality of rotatable louver units 410 comprising a cylinder, a ring 412 rotatably connected at the end of the cylinder of the rotatable louver unit 410 away from the panel on which the cylinder of the rotatable louver unit 410 is mounted, with a plurality of louver fins 420 mounted to the ring 412, each of the plurality of louver fins 420 having a hinged edge, with the hinged edge of each of the louver fins 420 rotatably connected to the ring 412 and perpendicular to the axis of the rotatable louver units 410 and thus parallel to that panel. It has been found advantageous to have the lighting elements 212 mounted on the louver fins 420. The ring 412 rotates in a plane parallel to that of the back panel 210, illustrated as ring rotation 414, and the louver fins 420 are attached to the ring 412, by the louver fin attachments 422. The louver fins 420 rotate within the ring 412, illustrated as louver fin rotation 424, which together with the ring rotation 414, allows control by the computer 154 to direct the lighting elements 212 side-to-side and up-down, to simulate the directionality of outside lighting conditions. In such embodiments of the present invention, it may be desirable to construct the NLSW 100 without a middle panel 220, instead attaching the rotatable louver units 410 to the back panel 210. In some such embodiments of the invention, the light redirection means 320, such as Fresnel lenses, may be mounted directly to the plurality of lighting elements 212 or to the plurality of louver fins 420 of the rotatable louver units 410, so that they are controlled together with the lighting elements 212. The rotatable louver units 410 are connected to the plurality of motors 152, which power both the ring rotation 414 and louver fin rotation 424. The enclosure formed by the plurality of panels may further comprise mounting means 140.

In other embodiments of the present invention, though not depicted in FIG. 4, the NLSW 100 may comprise a middle panel 220, and the plurality of lighting elements 212 may be mounted on the back panel 210 or the middle panel 220, and the rotatable louver units 410 may be mounted on the middle panel 220 over sets of a plurality of lighting elements 212, each such set of a plurality of lighting elements 212 comprising one or more of the plurality of lighting elements 212. The rotatable louver units 410 may be configured to cover a 2×2 grid of lighting elements 212, or larger grids or sets. As will be apparent to one of skill in the art, arranging the rotatable louver units 410 to cover 2×2 or larger sets of lighting elements 212 may require that the lighting elements 212 are not all placed in a rectangular grid pattern, but instead one or more of the sets of lighting elements 212, each covered by one of the rotatable louver units 410, may need to be arranged in a hexagonal closely-packed array or other arrangement. It may also be desirable to arrange the lighting elements 212 densely inside or underneath each of the rotatable louver units 410, and space the rotatable louver units 410 farther from each other.

In these embodiments of the present invention, each of the rotatable louver units 410 may have a ring 412 that can rotate with the depicted ring rotation 414, and each of the louver fins 420 may be hinged at the top edge, at the louver fin attachments 422, such that the bottom edges of the louver fins 420 can rotate in or out as the louver fin rotation 424, away from the back panel 210. The rotatable louver units 410 are connected to the plurality of motors 152, which power both the ring rotation 414 and louver fin rotation 424.

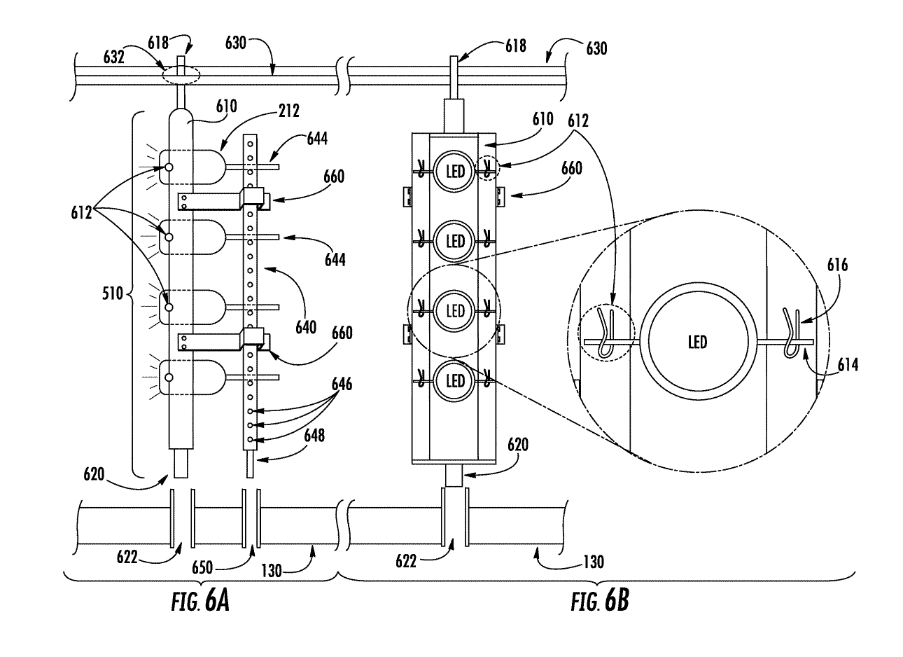

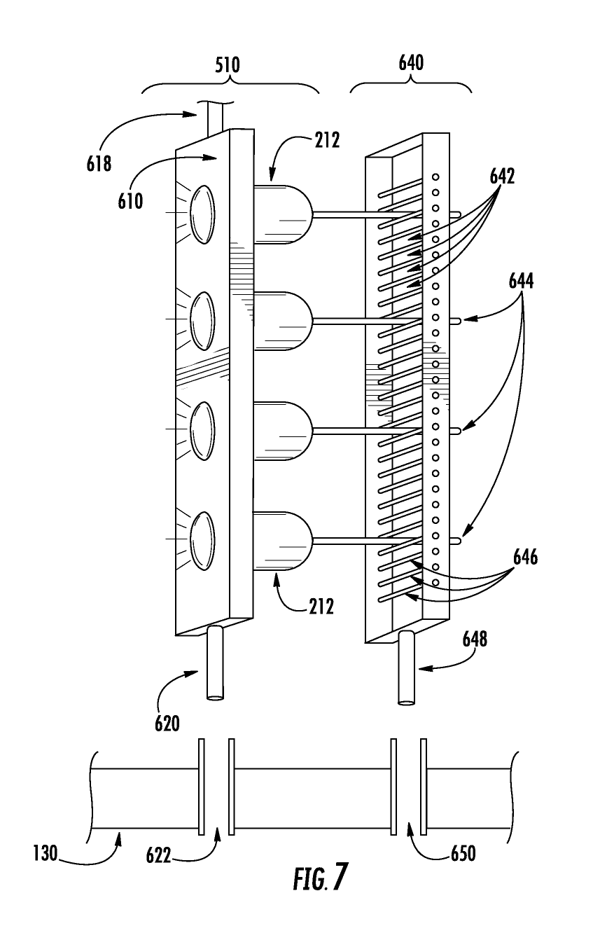

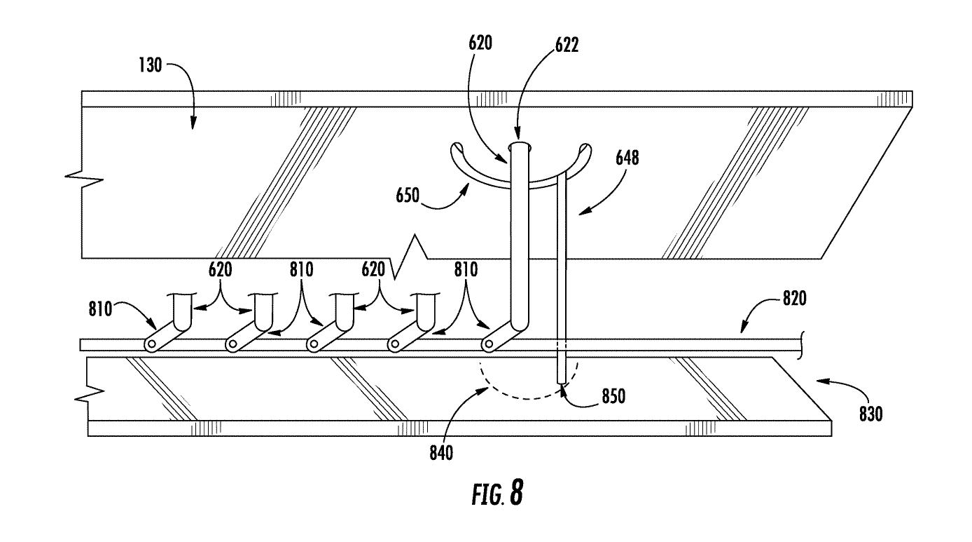

It has been found advantageous to have, as shown in FIG. 5, FIG. 6A, FIG. 6B, FIG. 7, and FIG. 8, the NLSW 100 comprise a plurality of panels fixedly connected to each other to form an enclosure, including but not limited to a back panel 210, and a front panel 230, as well as a plurality of side panels 110 and a top panel 120 and a bottom panel 130; any of the plurality of panels may have mounting means 140. The NLSW 100 may further comprise a plurality of lighting elements 212, a plurality of towers 510, a plurality of ladders 640, a power connection to a power source, a control means which may comprise a computer 154, and a plurality of motors 152. As described in greater detail below, in such embodiments, the lighting elements 212 may be mounted on towers 510 with the plurality of lighting elements 212 comprising a plurality of lighting element tails 644 projecting away from the towers 510 and into a plurality of element tail openings 642, the plurality of ladders 640 further comprising the element tail openings 642. In such embodiments, the towers 510 and the ladders 640 together are controlled by the computer 154 and the plurality of motors 152 to move the lighting elements 212 through both horizontal and vertical motion, to simulate real-time or programmed outdoor lighting conditions, as described below, and as described in a discussion of the inventive method. A wall 520, which may in some placements of the NLSW 100 may be a ceiling or other surface of a structure, is illustrated in FIG. 5, showing an embodiment of the present invention, and an arrangement by which the display portion 160 of the NLSW 100 may be visible while the operating tray 150 may be concealed behind such a wall 520 or other surface of the structure.

With reference to FIG. 6A and FIG. 6B, the plurality of towers 510 may further comprise lighting element attachment points 612 that may permit rotation of the lighting elements 212 about each of the lighting element attachment points 612, with the plurality of lighting elements 212 rotatably mounted to the plurality of towers 510 via the plurality of lighting element attachment points 612. The lighting element attachment points 612 may comprise laterally projecting bars 614 and hinge clips 616, or as will be apparent to one skilled in the art, may be achieved by other means now known or later invented.

It has been found advantageous to have the lighting elements 212 project through the towers 510, as shown in FIG. 6A, FIG. 6B, and FIG. 7. Each of the plurality of towers 510 comprises a tower body 610, to which the lighting elements 212 are fixedly mounted, which tower body 610 may be a panel or a bar or other shape, an upper tower stem 618 projecting away from the tower body, and a lower tower stem 620 projecting away from the tower body. The upper tower stem 618 of each of the towers 510 is rotatably attached to, which may comprise being set into, an upper tower stem opening 632 in the upper support panel 630, such that each of the towers 510 may rotate about the vertical axis of the towers 510. The upper support panel 630 is, it has been found advantageous, located inside the NLSW 100 towards the top of the NLSW 100 enclosure, and is fixedly attached to one or more of the plurality of side panels 110 and/or to the top panel 120. This rotation about a vertical axis of each of the towers 510 allows the NLSW 100 to simulate the apparent horizontal motion of the sun by tracking the emitted light horizontally across the room.

As shown in FIG. 6A, FIG. 6B, FIG. 7, and FIG. 8, in some embodiments of the present invention, each lower tower stem 620 is rotatably attached to a lower tower stem opening 622 in the bottom panel 130 of the NLSW 100, which rotatable attachment may comprise rotatably passing through a hole or void in the bottom panel. The plurality of lower tower stems may pass into the space of the operating tray 150 in embodiments of the present invention where the operating tray 150 is located below the bottom panel 130. Each lower tower stem 620 is attached to means to the tower rotation means 820, and the tower rotation means 820 is operably connected to and moved by the plurality of motors 152, with the motion of the tower rotation means 820 controlled by the control means, which may comprise a computer 154, to simulate real-time outdoor or programmed lighting conditions, as described in the discussion of the inventive method. It has been found advantageous to have such tower rotation means 820 attached to each of the plurality of lower tower stems 620 via a plurality of lower tower stem arms 810. Each lower tower stem arm 810 is attached to the tower rotation means 820. The tower rotation means 820 may be a bar or platform. The motion of the tower rotation means 820 may be laterally, i.e. side-to-side, or may be another motion that permits the towers 510 to move in a manner that allows realistic simulation of outdoor lighting conditions, or other desired light emission, by the NLSW 100. Because each lower tower stem 620 is connected by each lower tower stem arm 810 to the tower rotation means 820, or in other embodiments of the present invention, to other means of rotating each tower, all of the towers 510 rotate synchronously as the tower rotation means 820 moves horizontally inside the operating tray 150 of the NLSW 100.

With reference to FIG. 6A, FIG. 6B, and FIG. 7, each of the plurality of ladders 640 is situated behind each of the plurality of towers 510, from the perspective of the front of the NLSW 100. Each of the ladders 640 comprises element tail openings 642 into which the lighting element tails 644 of the lighting elements 212 project, as described above. In the embodiment of the present invention depicted in FIG. 6A, FIG. 6B, and FIG. 7, each of the plurality of ladders 640 comprise a rectangular frame of thin elements forming the sides, top, and bottom of the ladders 640, and horizontal rungs 646 spanning from one side of each of the ladders 640 to the other side of each of the ladders 640, with the voids between the rungs 646 the element tail openings 642 into which the lighting element tails 644 are placed. It will be obvious to one skilled in the art that each of the ladders 640 could be comprised of a frame made of bars or other shaped elements, or that each of the ladders 640 could comprise a panel with element tail openings 642 comprised of holes, voids, or other cavities in such a panel.

Each of the plurality of ladders 640 is attached to one of the plurality of towers 510, advantageously the tower nearest each ladder 640 and directly behind which the ladder 640 is situated, with a plurality of ladder anchors 660. Each ladder anchor 660 is fixedly mounted to a tower 510, and is slidably engaged with a ladder 640, such as by partly or completely surrounding a frame element of the ladder 640 if the ladder 640 is built with a flat element, or by other means such as surrounding or partly surrounding a ladder 640 comprised of a panel as described above. By slidably engaging each ladder 640 to the nearest tower 510, the ladder anchors 660 permit the ladders 640 a degree of movement in the vertical while restraining them from moving in a horizontal direction relative to the towers 510. When the ladders 640 are controlled by the computer 154 and the plurality of motors 152 to move up and down, as described below in a discussion of the inventive method, in the vertical direction which the ladder anchors 660 permit them, the motion of the ladders 640, with their component element tail openings 642, move the lighting element tails 644 down or up, thereby tilting the lighting elements 212 up or down as the lighting elements 212 rotate about their lighting element attachment points 612 as described above, enabling the NLSW 100 to simulate the verticality of outdoor or programmed lighting by projecting light into a room horizontally or at a downward or upward angle from the horizontal.

In some embodiments of the present invention, with reference to FIG. 6A, FIG. 6B, FIG. 7, and FIG. 8, each of the plurality of ladders 640 further comprises a ladder stem 648, which projects downward from each ladder 640, collectively comprising a plurality of ladder stems, and each of the plurality of ladder stems is moveably passed through a ladder stem opening 650 in, which may comprise being set into or passed through a hole or void in, the bottom panel 130 of the NLSW 100, the bottom panel 130 comprising a plurality of ladder stem openings 650, and may pass into the space of the operating tray 150. Each ladder stem opening 650 may be semi-circular or arc-shaped, as depicted in FIG. 8, or may have another shape. Each of the plurality of ladder stems 648 contacts a ladder elevation means 830, which the NLSW 100 further comprises, with the ladder elevation means 830 contained inside of the operating tray 150; the contact between each of the plurality of ladder stems 648 and the ladder elevation means 830 may comprise the plurality of ladder stems 648 resting on the ladder elevation means 830 without attachment to the ladder elevation means 830, or the contact may comprise the plurality of ladder stems 648 being fixedly or rotatably attached to the ladder elevation means 830. In the perspective of FIG. 8, the bottom panel 130 is presented in a front perspective view showing the underside of the bottom panel 130, and the ladder elevation means 830 is presented in a front perspective view showing the top side of the ladder elevation means 830. This view in FIG. 8 is a view of the inside of the operating tray 150, omitting the sides, back, and bottom of the operating tray 150, as well as the plurality of plurality of motors 152, the computer 154, the input/output means 156, and other mechanical and/or electrical components.

The ladder elevation means 830 may be a bar or platform or other suitable form, and the ladder elevation means 830 is operably connected to and moved by the plurality of motors 152, with the motion of the ladder elevation means 830 controlled by the computer 154, to simulate real-time outdoor or programmed lighting conditions. The ladder elevation means 830 elevates and lowers throughout the day or course of the program run by the computer 154, and thus elevates each of the ladders 640 synchronously. The ladder elevation means 830 may itself rotate about either its front or back edge, impelled by the plurality of motors 152, or may maintain a horizontal orientation and be raised and lowered by the plurality of motors 152, or may be moved in another manner, as will be clear to one skilled in the art, all of which motions of the ladder elevation means 830 serve to raise or lower the ladders 640.

As the ladders 640 are raised or lowered by the ladder elevation means 830, each of the ladders 640 being slidably engaged with its respective ladder anchors 660 attached to the respective towers 510, the lighting element tails 644 in the element tail openings 642 are moved higher or lower, causing the lighting elements 212 to rotate about the horizontal axis of their respective lighting element attachment points 612, and thus causing the light emitted from the NLSW 100 to be directed horizontally into the room or at an angle from the horizontal. This motion, in combination with the synchronous rotation of the towers 510, allows the NLSW 100 to accurately and realistically simulate real-time or programmed outdoor lighting conditions. Note that as the towers 510 are rotated by the tower rotation means 820, the ladders 640 rotate synchronously with the towers 510, with each of the ladder anchors 660 exerting the horizontal force on each of the ladders 640, causing the ladders 640 to rotate synchronously with the towers 510. As the ladders 640 rotate, their path defines an arc, the track of which is apparent in the semi-circular or arc shape of the ladder stem opening 650, and which is further illustrated as the ladder stem track 840 on the ladder elevation means 830 in FIG. 8. In some embodiments of the present invention, each of the plurality of ladder stems 648 may have a low-friction point of contact at the ladder stem end 850 (the plurality of ladder stems further comprising a plurality of ladder stem ends) with the ladder elevation means 830, which ladder elevation means 830 may be treated or coated with a low-friction surface, to allow the ladder stems 648 to slide across the ladder elevation means 830 without sticking or binding. In other embodiments, each of the plurality of ladder stems 648 may terminate in a mechanism attaching that ladder stem to a curved track, a plurality of curved tracks being fixed to the ladder elevation means 830, in the location of the depicted ladder stem track 840, such that the ladder stems 648 may be fixed to the ladder elevation means 830 in a low-friction manner.

Other embodiments of the present invention may include a larger or window sized circular mechanism, like a single large rotatable louver unit with lighting elements 212 and light redirection means 320 mounted directly on to the rotatable louver. In such an embodiment, the side panels 110 and top panel 120 and bottom panel 130 are not present, replaced instead with a plurality of panels comprising a large cylinder. Such an embodiment of the present invention may be covered with a rectangular or other shape of front panel 230, to be mounted in a building and have front louvers and decorative elements as described above, including but not limited to mullions, muntins 242, and/or curtains. Still other embodiments may have a circular NLSW 100, as described above, so that the NLSW 100 may appear to be and imitate a porthole as on a ship.

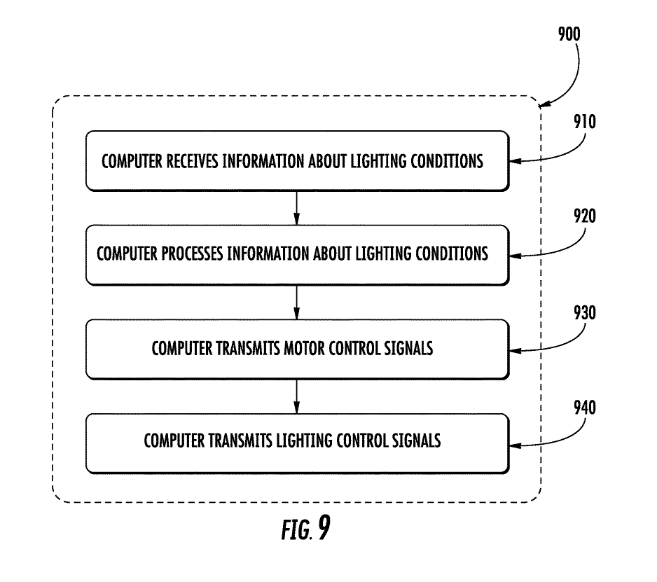

The methods 900 carried out by the present invention include, with reference to FIG. 9, references to a computer 154, which is to be understood to be an advantageous but not the only possible embodiment of the control means, as the control means could also be a mechanical system, for instance similar to a clockwork mechanism. In an advantageous embodiment of the present invention, the computer 154 receives 910 a first set of information about lighting conditions to emulate, including but not limited to directionality or diffuseness of incoming light, brightness of light, and color spectrum of light. The computer 154 then processes 920 the first set of information about the lighting conditions. Such processing 920 may comprise the computer 154 accessing and analyzing information from the plurality of photosensors 170, or from the internet 182, or from a user device 180, and using that information about the lighting conditions to emulate to determine how the lighting elements 212 should be controlled for light emitted, including but not limited to brightness and color spectrum, and how the plurality of motors 152 should be controlled to position the moveable components of a given embodiment of the present invention to emulate the directionality or diffuseness of the lighting conditions to emulate, as described in greater detail above and below. The computer 154 may receive the first set of information from a plurality of photosensors 170, or from other sources. In some embodiments of the present invention, the computer 154 may a plurality of sets of information regarding lighting conditions to emulate, at a plurality of times.

The computer 154 then transmits motor control signals 930 to the plurality of motors 152, such that the plurality of motors 152 may direct the location and orientation of the lighting elements 212, and in certain embodiments of the present invention, the means to direct or orient the light emitted by the lighting elements 212, including but not limited to a moveable middle panel 220 or back panel 210, moveable lighting elements 212, rotatable louver units 410, rotatable louver fins 420, rotatable towers 510, and/or ladders 640, or other components comprising other embodiments of the present invention. The computer 154 may transmit motor control signals 930 to the plurality of plurality of motors 152 over the course of a day to accurately simulate the tracking of the sun across the sky, or other lighting conditions.

The computer 154 also transmits lighting control signals 940 to a plurality of lighting elements 212, which lighting control signals 940 may vary sufficiently rapidly to simulate real-time lighting conditions, or the computer 154 may be programmed or controlled to transmit lighting control signals 940 to simulate any other lighting conditions. The transmitted lighting control signals 940 contain information determining how much light the lighting elements 212 emit, and the spectrum of that light, e.g. if there are lighting elements 212 that emit different colors of light, the transmitted lighting control signals 940 may separately control one or more pluralities of the lighting elements 212 to alter the overall spectrum of light emitted from the NLSW 100 and relative intensities of light of different visible colors, i.e. wavelengths or wavelength ranges.

Certain embodiments of the present invention were described above. It is expressly noted that the present invention is not limited to those embodiments, but rather the intention is that additions and modifications to what was expressly described herein are also included within the scope of the invention. Moreover, it is to be understood that the features of the various embodiments described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative descriptions.

Accordingly, we claim:

1. An apparatus for indoor simulation of real-time or programmed outdoor lighting, the apparatus comprising:
a plurality of panels fixedly connected to each other to form an enclosure;
a plurality of lighting elements disposed in the enclosure;
a power connection to a power source;
a plurality of motors; and
a control means;
in which the plurality of lighting elements and the plurality of motors are connected electrically to the control means and the power connection.

2. The apparatus of claim 1, in which the plurality of panels comprises:
a back panel;
a front panel;
a plurality of side panels;
a top panel;
and a bottom panel.

3. The apparatus of claim 1, in which the apparatus further comprises mounting means attached to any of the plurality of panels.

4. The apparatus of claim 2, in which the plurality of panels further comprises a middle panel, the middle panel having a plurality of holes, and the middle panel being disposed between the back panel and the front panel.

5. The apparatus of claim 1, in which the plurality of panels further comprises a trim panel.

6. The apparatus of claim 1, in which the apparatus further comprises an operating tray.

7. The apparatus of claim 6, in which the operating tray further comprises a location for containing components.

8. The apparatus of claim 4, in which the plurality of lighting elements are attached to the back panel.

9. The apparatus of claim 1, in which the plurality of lighting elements are light-emitting diodes.

10. The apparatus of claim 8, in which each of the plurality of lighting elements is attached to the back panel with one or more of a plurality of connectors.

11. The apparatus of claim 10, in which each of the plurality of connectors comprises a ball and a socket.

12. The apparatus of claim 10, in which the neutral position of the connectors has the lighting elements oriented perpendicularly to the back panel.

13. The apparatus of claim 1, in which the control means comprise a computer.

14. The apparatus of claim 12, in which a plurality of the holes align with the lighting elements when the lighting elements are in their neutral position.

15. The apparatus of claim 4, in which the plurality of holes are circular and aligned concentrically with the long axis of the lighting elements.

16. The apparatus of claim 4, in which the middle panel has light redirection means attached to the middle panel.

17. The apparatus of claim 4, in which the plurality of holes are lined with a plurality of hole liners.

18. The apparatus of claim 4, in which an element of the apparatus is moveable.

19. The apparatus of claim 18, in which the moveable element is the back panel, which is moveably connected to other elements of the enclosure.

20. The apparatus of claim 18, in which the moveable element is the middle panel, which is moveably connected to other elements of the enclosure.

21. The apparatus of claim 18, in which the moveable element is one or more of the lighting elements, which are moveably connected to other elements of the enclosure.

22. The apparatus of claim 17, in which the plurality of hole liners are disposed concentrically with the plurality of lighting elements and concentrically inside of the plurality of holes.

23. The apparatus of claim 18, in which the motion of the moveable element is controlled by the control means.

24. The apparatus of claim 23, in which the apparatus further comprises one or more photosensors, and the control means are connected to the one or more photosensors.

25. The apparatus of claim 24, in which one or more of the photosensors is a right-angle reflector.

26. The apparatus of claim 23, in which the control means are connected to instruments located remotely.

27. The apparatus of claim 23, in which the control means are controlled to display a programmed simulated time period.

28. The apparatus of claim 2, in which the front panel comprises material to diffuse light from the plurality of lighting elements.

29. The apparatus of claim 2, in which the apparatus further comprises front louvers.

30. The apparatus of claim 2, in which the apparatus further comprises window-trim components.

31. An apparatus for indoor simulation of real-time or programmed outdoor lighting, the apparatus comprising:
a plurality of panels fixedly connected to each other to form an enclosure;
a plurality of lighting elements disposed in the enclosure;
a plurality of rotatable louver units;
a power connection to a power source;
a plurality of motors; and
a control means;
in which the plurality of lighting elements and the plurality of motors are connected electrically to the control means and the power connection;
and in which each of the plurality of rotatable louver units is mounted to one of the plurality of panels, and in which each of the plurality of rotatable louver units further comprises:
a cylinder;
a ring rotatably connected at the end of the cylinder away from the panel on which the cylinder is mounted, for a ring rotation;
a plurality of louver fins rotatably connected to the ring, being attached to the ring by a plurality of louver fin attachments, for a louver fin rotation;
each of the plurality of the louver fins having a hinged edge which is perpendicular to the axis of the cylinder of the rotatable louver units;
the ring being rotatable about the axis of the cylinder; and
the plurality of louver fins being rotatable within the ring about the hinged edge of each of the plurality of louver fins;
and in which the plurality of motors powers the ring rotation and the louver fin rotations.

32. The apparatus of claim 31, in which the plurality of panels comprises:
a back panel;
a front panel;
a plurality of side panels;
a top panel;
and a bottom panel.

33. The apparatus of claim 31, in which the apparatus further comprises mounting means attached to any of the plurality of panels.

34. The apparatus of claim 32, in which the plurality of panels further comprises a middle panel, the middle panel being disposed between the back panel and the front panel.

35. The apparatus of claim 31, in which the plurality of lighting elements are mounted on the plurality of louver fins.

36. The apparatus of claim 34, in which the plurality of lighting elements are mounted on the back panel or the middle panel, and the rotatable louver units are mounted on the middle panel over sets of a plurality of lighting elements.

37. The apparatus of claim 31, in which the apparatus further comprises light redirection means mounted directly to the plurality of lighting elements.

38. The apparatus of claim 31, in which the apparatus further comprises light redirection means mounted directly to the plurality of louver fins.

39. An apparatus for indoor simulation of real-time or programmed outdoor lighting, the apparatus comprising:
a plurality of panels fixedly connected to each other to form an enclosure;
a plurality of lighting elements disposed in the enclosure;
a plurality of towers;
a plurality of ladders;
a power connection to a power source;
a plurality of motors;
a control means; and
an operating tray;
in which the plurality of lighting elements and the plurality of motors are connected electrically to the control means and the power connection; and
each of the plurality of ladders is situated behind each of the plurality of towers.

40. The apparatus of claim 39, in which the plurality of panels comprises:
a back panel;
a front panel;
a plurality of side panels;
a top panel;
and a bottom panel.

41. The apparatus of claim 39, in which the apparatus further comprises mounting means attached to any of the plurality of panels.

42. The apparatus of claim 39, in which the plurality of ladders further comprises a plurality of element tail openings; and the plurality of lighting elements further comprise a plurality of lighting element tails, the plurality of lighting element tails projecting away from the towers and into the plurality of element tail openings.

43. The apparatus of claim 39, in which the plurality of towers further comprise a plurality of lighting element attachment points; and the plurality of lighting elements are rotatably mounted to the plurality of towers via the plurality of lighting element attachment points.

44. The apparatus of claim 43, in which the lighting element attachment points further comprise laterally projecting bars and hinge clips.

45. The apparatus of claim 40, in which:
each of the plurality of towers further comprises a tower body, an upper tower stem projecting away from the tower body, and a lower tower stem projecting away from the tower body; collectively comprising a plurality of tower bodies, a plurality of upper tower stem arms, and a plurality of lower tower stem arms, and the plurality of lighting elements are fixedly mounted to the plurality of towers; and
the plurality of panels further comprises an upper support panel, the upper support panel further comprising a plurality of upper tower stem openings; and
the upper tower stems of each of the plurality of towers are rotatably attached to the plurality of upper tower stem openings; and
the bottom panel further comprises a plurality of lower tower stem openings;
the lower tower stems of each of the plurality of towers are rotatably attached to the plurality of lower tower stem openings; and
the apparatus further comprises tower rotation means; and
the plurality of lower tower stems are attached to the tower rotation means; and
the tower rotation means are operably connected to and moved by the plurality of motors.

46. The apparatus of claim 45, in which the upper support panel is located inside the enclosure towards the top of the enclosure, and the upper support panel is fixedly attached to one or more of the plurality of side panels and/or to the top panel.

47. The apparatus of claim 45, in which the tower rotation means are attached to each of the plurality of lower tower stems via a plurality of lower tower stem arms, and each of a plurality of lower tower stem arms is attached to the tower rotation means.

48. The apparatus of claim 47, in which:
each of the plurality of ladders further comprises a plurality of element tail openings; and
the plurality of lighting elements further comprise a plurality of lighting element tails; and
the plurality of lighting element tails project away from the plurality of towers and into the plurality of element tail openings; and
the plurality of towers further comprise a plurality of lighting element attachment points; and
the plurality of lighting elements are rotatably mounted to the plurality of towers via the plurality of lighting element attachment points; and
each of the plurality of ladders is attached to one of the plurality of towers with a plurality of ladder anchors; and
each ladder anchor is fixedly mounted to a tower, and is slidably engaged with a ladder.

49. The apparatus of claim 48, in which each of the plurality of ladders further comprises:
a rectangular frame of thin elements forming the sides, top, and bottom of each of the plurality of ladders; and
a plurality of horizontal rungs spanning from one side of each of the ladders to the other side of each of the ladders;
with the voids between the plurality of horizontal rungs comprising the plurality of element tail openings.

50. The apparatus of claim 48, in which:
the apparatus further comprises ladder elevation means, contained inside of the operating tray; and
the bottom panel further comprises a plurality of ladder stem openings; and
each of the plurality of ladders further comprises a ladder stem, which projects downward from each ladder; collectively a plurality of ladder stems; and
each of the plurality of ladder stems is moveably passed through one of the plurality of ladder stem openings; and
each of the plurality of ladder stems contacts the ladder elevation means;
and the ladder elevation means is operably connected to and moved by the plurality of motors.

51. The apparatus of claim 50, in which:
each of the plurality of ladder stems further comprises a ladder stem end, collectively a plurality of ladder stem ends;
the plurality of ladder stem ends having a low-friction point of contact with the ladder elevation means; and
the ladder elevation means being treated with a low-friction surface.

52. The apparatus of claim 50, in which:
the ladder elevation means further comprise a plurality of curved tracks; and
each of the plurality of ladder stems terminates in a mechanism attaching that ladder stem to one of the plurality of curved tracks.

53. The apparatus of claim 39, in which the apparatus further comprises one or more photosensors, and the control means are connected to the one or more photosensors.

54. The apparatus of claim 53, in which one or more of the photosensors is a right-angle reflector.

55. The apparatus of claim 40, in which the front panel comprises material to diffuse light from the plurality of lighting elements.

56. The apparatus of claim 31, in which the apparatus further comprises one or more photosensors, and the control means are connected to the one or more photosensors.

57. The apparatus of claim 56, in which one or more of the photosensors is a right-angle reflector.

58. The apparatus of claim 32, in which the front panel comprises material to diffuse light from the plurality of lighting elements.

59. A method for indoor simulation of real-time or programmed outdoor lighting, the method comprising:
a computer receives a first set of information about lighting conditions to emulate;
the computer processes the first set of information;
the computer transmits motor control signals to a plurality of motors; and
the computer transmits lighting control signals to a plurality of lighting elements.

60. The method of claim 59, in which the computer receives a plurality of sets of information regarding lighting conditions to emulate, at a plurality of times.

61. The method of claim 59, in which:
the first set of information comprises information regarding current local outdoor lighting conditions; and
the motor control signals and the lighting control signals comprise emulations of local outdoor lighting conditions.

62. The method of claim 59, in which the computer transmits a first set of lighting control signals to a first plurality of lighting elements, and the computer transmits a second set of lighting control signals to a second plurality of lighting elements.

63. The method of claim 59, in which the first set of information comes from instruments located remotely and transmitting real-time data.

64. The method of claim 59, in which the first set of information is a programmed simulated time period of lighting.
